(19) United States
(12) Patent Application Publication
(10) Pub. No.: US 2017/0151735 A1
(43) Pub. Date: Jun. 1, 2017

(54) METHOD OF MANUFACTURING RIMLESS EYEGLASS LENS AND METHOD OF MANUFACTURING RIMLESS EYEGLASSES

(71) Applicant: Oceanus Investment Inc., Mahe (SC)

(72) Inventor: Zhao-Yun HE, Shenzhen (CN)

(21) Appl. No.: 14/953,719

(22) Filed: Nov. 30, 2015

(51) Int. Cl. B29D 11/00

(52) U.S. Cl. CPC B29D 11/00519; B29K 2105/0067

(57) ABSTRACT

A method of manufacturing a rimless eyeglass lens includes: providing a lens-forming mold assembly that Includes first and second molds cooperatively defining a lens-forming cavity, the second mold including a base and at least two pin units mounted on the base, each of the pin units including at least one pin that projects from the base toward the first mold; injecting a molten plastic material into the lens-forming cavity under an injection pressure while maintaining the first and second molds at a melting temperature of the plastic material; and cooling the molten plastic material to form a rimless eyeglass lens having a shape corresponding to that of the lens-forming cavity and being formed with two through-hole units corresponding to the pin units.

### FIELD

The disclosure relates to a method of manufacturing rimless eyeglass lens and a method of manufacturing rimless eyeglasses including the rimless eyeglass lens.

### BACKGROUND

Eyeglasses are generally classified into two types: frame eyeglasses and rimless eyeglasses, the latter of which is more lightweight compared to the former.

FIG. 1 illustrates a manufacturing process of conventional rimless eyeglasses. Standard, circular lenses are first manufactured by lens factories for eyeglass stores. The lenses are then cut into the desired shape and drilled with multiple through holes by the eyeglass stores. Lastly, a bridge and two temples are connected to the lenses with screws to obtain the conventional rimless eyeglasses.

Although custom-made eyeglasses could satisfy customers' need for particular lens shapes, the process itself may be inconvenient and costly for the eyeglass stores since the cutting and drilling of the lenses often need to be outsourced. The outsourcing not only reduces the profit of the eyeglass stores, but also prolongs the overall production period of the eyeglasses due to the extra time required for shipping to and fro. Moreover, not only is the cutting process time-consuming, but since the through holes are formed near edges of the lenses, any excessive stress applied during the drilling process may cause the lenses to break, lowering the yield and profit thereof.

### SUMMARY

Therefore, an object of the disclosure is to provide a method of manufacturing a rimless eyeglass lens that say alleviate at least one of the drawbacks of the prior art.

A first aspect of the present disclosure is to provide a method of manufacturing a rimless eyeglass lens including the following steps:

(a) providing a lens-forming mold assembly that includes first and second molds cooperatively defining a lens-forming cavity, the second mold including a base and a pair of pin units that are mounted on the base opposite to each other, each of the pin units including at least one pin that projects from the base toward the first mold;

(b) injecting a molten plastic material into the lens-forming cavity under an injection pressure while maintaining the first and second molds at a melting temperature of the plastic material; and

(c) cooling the molten plastic material so as to form a rimless eyeglass lens that has a shape corresponding to that of the lens-forming cavity and that is formed with a pair of through-hole units corresponding to the pin units.

A second aspect of the present disclosure is to provide a method of manufacturing rimless eyeglasses including the following steps:

(a) providing a lens-forming mold assembly that includes a first and second molds cooperatively defining a lens-forming cavity, the second molding including a base and a pair of pin units that are mounted on the base opposite to each other, each of the pin units including at least one pin that projects from the base toward the first mold;

(b) injecting a molten plastic material into the lens-forming cavity under an injection pressure while maintaining the first and second molds at a melting temperature of the plastic material;

(c) cooling the molten plastic material so as to form a rimless eyeglass lens that has a shape corresponding to that of the lens-forming cavity and that is formed with a pair of through hole units corresponding to the pin units and being respectively located at opposite inner and outer sides of the rimless eyeglass lens;

(d) repeating steps (a) to (c) so as to obtain another rimless eyeglass lens; and

(e) providing a bridge unit, a pair of temple units and a plurality of fixing units, the bridge unit and the temple units being connected to the rimless eyeglass lenses through the fixing units.

### BRIEF DESCRIPTION OF THE DRAWINGS

Other features and advantages of the present disclosure will become apparent in the following detailed description of the embodiments with reference to the accompanying drawings, of which:

FIG. 1 shows consecutive steps of a method of manufacturing conventional rimless eyeglasses;

FIG. 2 is a flow chart of an embodiment, of a method of manufacturing a rimless eyeglass lens according to the present disclosure;

FIG. 3 is a fragmentary perspective view of a lens-forming mold assembly used in the embodiment of the present disclosure;

FIG. 4 is a cross-sectional view of the lens-forming mold assembly shown in FIG. 3;

FIG. 5 is a fragmentary exploded perspective view of a pair of rimless eyeglasses as manufactured by the embodiment;

FIG. 6 is a cross-sectional view of a variation of the lens-forming mold assembly used in the embodiment of the present disclosure;

FIG. 7 is a schematic view showing another variation of the lens-forming mold assembly used in the embodiment of the method of the present disclosure, in which only a second mold of the lens-forming mold assembly is shown;

FIG. 8 is a schematic view of the rimless eyeglass lens manufactured by the lens-forming mold assembly shown in FIG. 7;

FIG. 9 is a schematic view showing yet another variation of the lens-forming mold assembly used in the embodiment of the method of the present disclosure, in which only the second mold of the lens-forming mold assembly is shown;

FIG. 10 is a schematic view of the rimless eyeglass lens manufactured by the lens-forming mold assembly shown in FIG. 9;

FIG. 11 is a schematic view showing still yet another variation of the lens-forming mold assembly used in the embodiment of the method of the present disclosure, in which only the second mold of the lens-forming mold assembly is shown; and

FIG. 12 is a schematic view of the rimless eyeglass lens manufactured by the lens-forming mold assembly shown in FIG. 11.

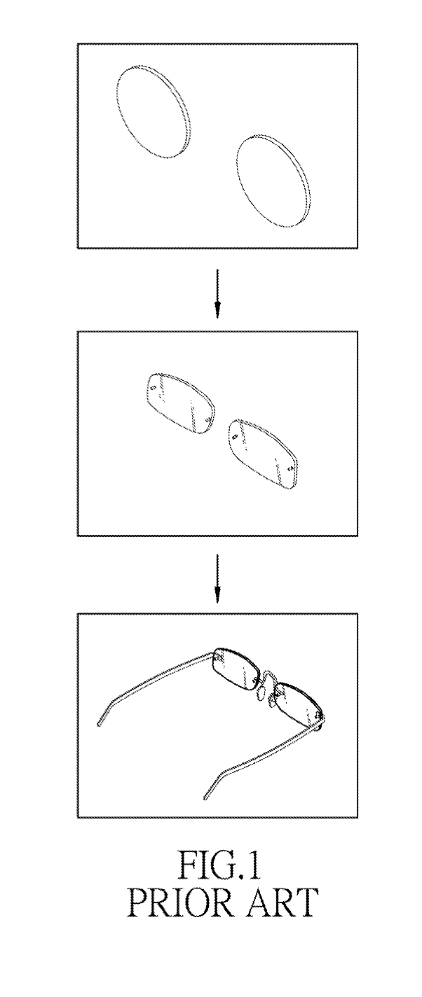

### DETAILED DESCRIPTION

Before the disclosure is described in greater detail with reference to the accompanying embodiment and variation of the embodiment, it should be noted herein that like elements are denoted by the same reference numerals throughout the disclosure.

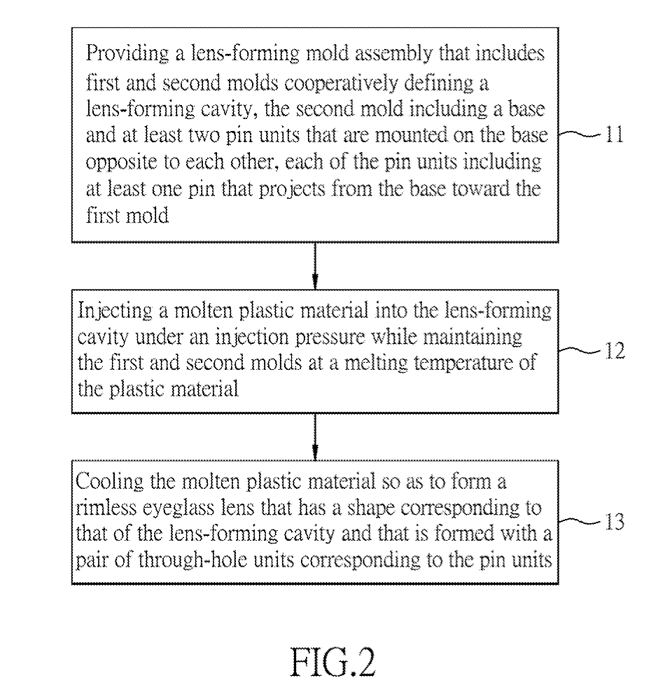

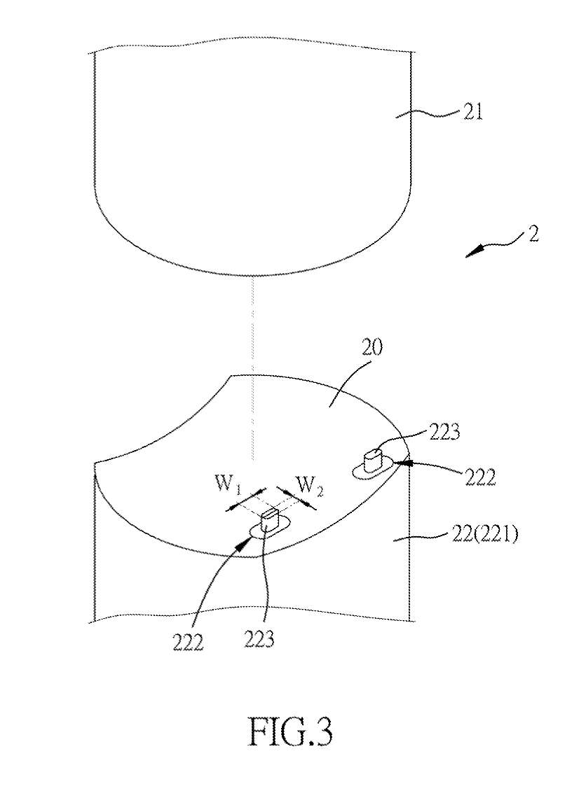

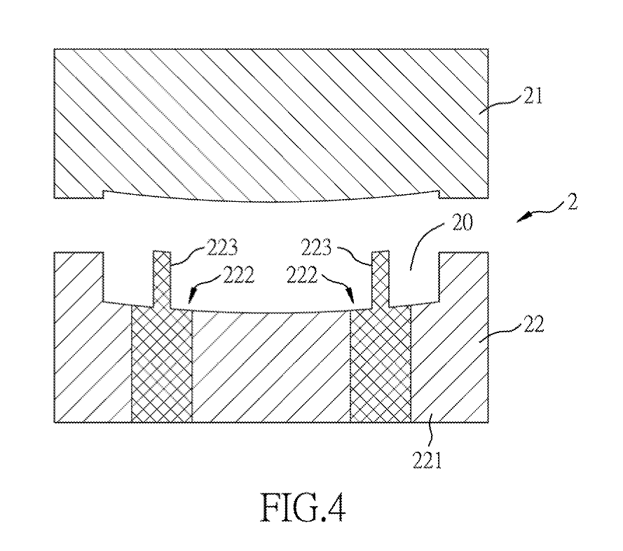

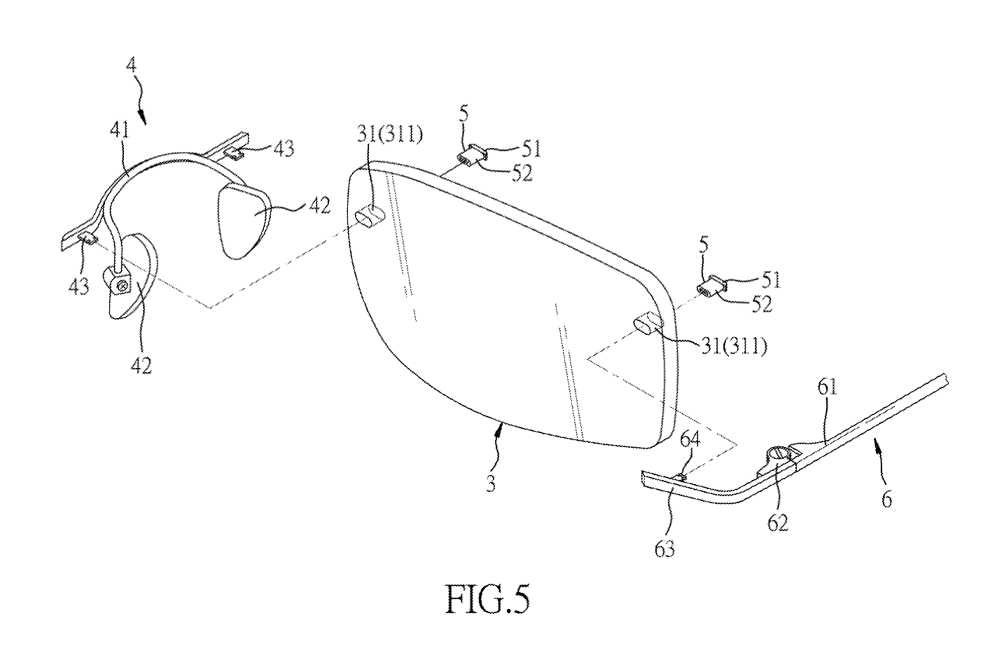

FIG. 2 is a flow chart showing an exemplary embodiment of a method of manufacturing a rimless eyeglass lens (see FIG. 5) according to the present disclosure utilizing a lens-forming mold assembly 2 as shown in FIGS. 3 and 4.

The lens-forming mold assembly 2 is first provided, which includes first and second molds 21, 22 that cooperatively define a lens-forming cavity 20. The lens-forming cavity 20 may be egg-shaped, rectangular-shaped, polygonal-shaped, etc. The second mold 22 includes a base 221, a peripheral wall extending from a peripheral region of the base 221, and a pair of pin units 222 that are mounted on the base 221 opposite to each other. Each of the pin units 222 includes a pin 223 that projects from the base 221 upwardly toward the first mold 21. The pin 223 of each of the pin units 222 has a cross section, which has a first maximum width (W1) along an imaginary line passing through centers of the pins 223 of the two pin units 222, and a second maximum width (W2) in a direction perpendicular to the imaginary line. In certain embodiments of the disclosure, the first maximum width (W1) is larger than the second maximum width (W2). In certain embodiments of the disclosure, the cross section of the pin 223 of each of the pin units 222 is elliptic in shape.

Then, a molten plastic material is injected into the lens-forming cavity 20 under an injection pressure while maintaining the first and second molds 21, 22 at a melting temperature of the plastic material. In this embodiment, the injection pressure is 75 Pascal and the melting temperature ranges from 190° C. to 240° C. The injection pressure may be changed according to the settings of different injection molding machines and should not be limited by the embodiment of the present disclosure.

Next, the molten plastic material and the first and second molds 21, 22 are cooled so as to form a rimless eyeglass lens 3 that has a shape corresponding to that of the lens-forming cavity 20 and that is formed with a pair of through-hole units 31 corresponding to the pin units 222 and being respectively located at opposite inner and outer sides of the rimless eyeglass lens 3. Each of the through-hole units 31 has a through-hole 311 that is configured as a wide hole, and may be egg-shaped, rectangular-shaped, etc.

Repeating the abovementioned steps, another rimless eyeglass lens 3 can be obtained.

It should be noted that, if necessary, the rimless eyeglass lens 3 may be polished and cleaned.

It is worth mentioning that the pin units 222 may be mounted on a base of the first mold 21. The pin 223 of each of the pin units 222 projects downwardly from the base of the first mold 21 toward the second mold 22.

FIG. 5 is a fragmentary perspective view of a pair of rimless eyeglasses that includes one of the rimless eyeglass lenses 3 manufactured by the abovementioned method, a bridge unit 4, a plurality of fixing units 5 and one of the temple units 6. The bridge unit 4 and the temple unit 6 are connected to the rimless eyeglass lenses 3 through the fixing units 5.

To be more specific, the bridge unit 4 is made by metal injection molding and includes a bridge member 41, two pad members 42 extending from the bridge member 41, and a pair of bridge engaging members 4 3 disposed on the bridge member 41 opposite to each other. Each of the fixing units 5 is made of an elastic material by injection molding and has a base member 51 and a coupling member 52 that extends from the base member 51 and that is snugly fitted into a respective one of the through-hole units 31. Each of the temple units 6 is made by metal injection molding and includes a connecting member 63, a hinge member 62 connected to one end of the connecting member 63, a temple engaging member 64 disposed on another end of the connecting member 63, and a temple member 61 pivotally connected to the hinge member 62. The bridge engaging members 43 of the bridge unit 4 tightly and respectively engage the coupling members 52 of two of the fixing units 5 that are respectively and snugly fitted into the through-hole units 31 respectively located at the inner sides of the rimless eyeglass lenses 3 so as to firmly connect the bridge unit 4 to the inner sides of the rimless eyeglass lenses 3. The temple engaging members 64 of the temple units 6 tightly and respectively engaging the coupling members 52 of two of the fixing units 5 that are respectively and snugly fitted into the through-hole units 31 located at the outer sides of the rimless eyeglass lenses 3 so as to firmly and respectively connect the temple units 6 to the outer sides of the rimless eyeglass lenses 3.

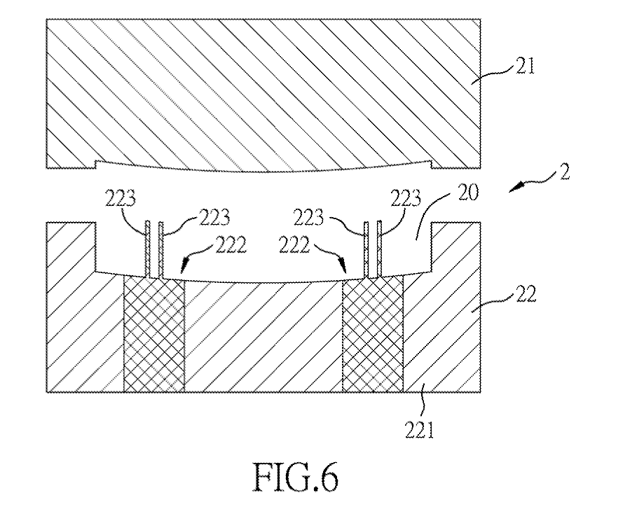

FIG. 6 shows a variation of the lens-forming mold assembly 2 used in the embodiment of the present disclosure, in the variation, each of the pin units 222 includes a pair of adjacent pins 223, each of which has a circle-shaped cross section, so that each of the through-hole units 31 thus formed has a pair of circle-shaped through-holes 311. With each of the through-hole units 31 having a pair of the through-holes 311, the numbers of the fixing units 5, bridge engaging members 4 3 and the temple engaging members 64 are changed accordingly to more fixedly connect the bridge unit 4 and the temple units 6 to the rimless eyeglass lenses 3.

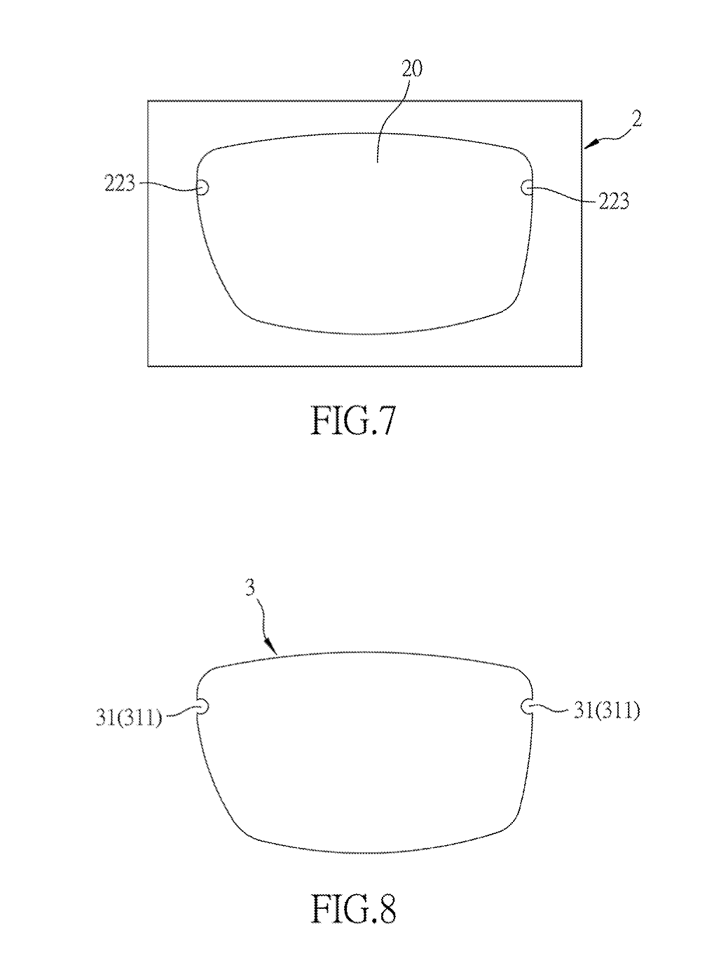

FIGS. 7 and 8 respectively show another variation of the lens-forming mold assembly 2 used in the embodiment of the present disclosure and the rimless eyeglass lens 3 made thereby. The lens-forming mold assembly 2 of this variation has a structure similar to the lens-forming mold assembly shown in FIGS. 3 and 4, except that, in this variation, the pin 223 of each of the pin units 222 has a circle-shaped cross section and abuts against the peripheral wall of the second mold 22, so that the through-hole 311 of each of the through-hole units 31 manufactured thereby is located at a periphery of the rimless eyeglass lens 3 and is configured as a circular notch.

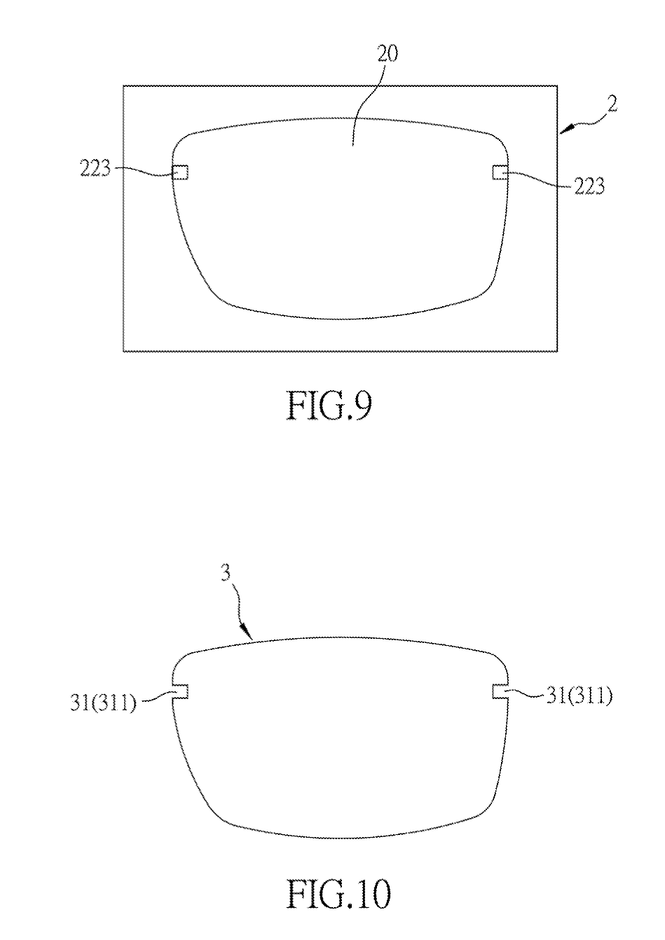

FIGS. 9 and 10 illustrate yet another variation of the lens-forming mold assembly 2 and the rimless eyeglass lens 3 made thereby. The lens-forming mold assembly 2 of this variation has a structure similar to that of the lens-forming mold assembly shown in FIG. 7. The difference resides in that the pin 223 of each of the pin units 222 has a rectangle-shaped cross section, so that the through-hole 311 of each of the through-hole units 31 is configured as a rectangular notch.

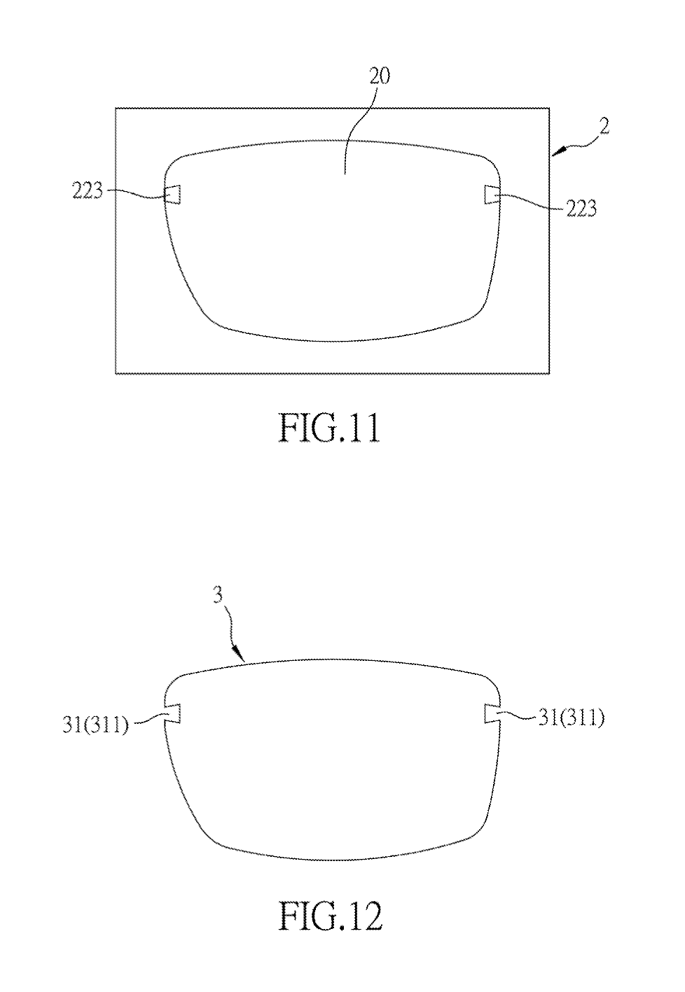

FIGS. 11 and 12 illustrate still yet another variation of the lens-forming mold assembly 2 and the rimless eyeglass lens 3 made thereby. The lens-forming mold assembly 2 of this variation has a structure similar to that of the lens-forming mold assembly shown, in FIG. 7. The difference resides in that the pin 223 of each of the pin units 222 has a trapezoid-shaped cross section, so that the through-hole 311 of each of the through-hole units 31 is configured as a trapezoid notch.

It should be noted that the shape of the cross section and the position of the pin 223 of each of the pin units 222 may vary based on actual requirement.

To sum up, the rimless eyeglass lens formed by the method of this disclosure has a predetermined shape and is formed to include the through-hole units 31. Compared to the conventional method, the cutting and drilling processes can be omitted entirely from the method of the present disclosure. Moreover, with the bridge engaging members 43, the temple engaging member 64 and the fixing units 5, the bridge unit and the temple units 6 can be connected to the rimless eyeglasses lenses 3 without the use of screws and nuts. Thus, drawbacks caused by excessively tight or loose engagement between the screws and the nuts (e.g., breaking/detachment of the lenses) may be prevented.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method of manufacturing a rimless eyeglass lens, comprising the following steps:
(a) providing a lens-forming mold assembly that includes first and second molds cooperatively defining a lens-forming cavity, the second mold including a base and at least two pin units that are mounted on the base opposite to each other, each of the pin units including at least one pin that projects from the base toward the first mold;
(b) injecting a molten plastic material into the lens-forming cavity under an injection pressure while maintaining the first and second molds at a melting temperature of the plastic material; and
(c) cooling the molten plastic material so as to form a rimless eyeglass lens that has a shape corresponding to that of the lens-forming cavity and that is formed with a pair of through-hole units corresponding to the pin units.

2. The method as claimed in claim 1, further comprising step (a) of removing the rimless eyeglass lens from the lens-forming mold assembly, followed by polishing and cleaning the rimless eyeglass lens.

3. The method, as claimed in claim 1, wherein the melting temperature in step (b) ranges from 190° C. to 240° C., the injection pressure being 75 Pascal.
4. The method as claimed in claim 1, wherein each of the pin units includes a pin having a cross section, the cross section of the pin having a first maximum width along an imaginary line passing through centers of the pins of the two pin units, and a second maximum width in a direction perpendicular to the imaginary line, the first maximum width being larger than the second maximum width.

5. The method as claimed in claim 1, wherein each of the pin units includes two adjacent pins, each of pins having a circle-shaped cross section.

6. The method as claimed in claim 1, wherein the second mold further includes, a peripheral wall extending from a peripheral region of the base toward the first mold, the at least one pin of each of the at least two pin units abutting against the peripheral wall.

7. The method as claimed in claim 6, wherein the at least one pin of each of the at least two pin units has a circle-shaped cross section, a rectangle-shaped cross section or a trapezoid-shaped cross section.

8. A method of manufacturing a pair of rimless eyeglasses comprising the following steps:
(a) providing a lens-forming mold assembly that includes a first and second molds cooperatively defining a lens-forming cavity, the second mold including a base and at least two pin units that are mounted on the base opposite to each other, each of the pin units including at least one pin that projects from the base toward the first mold;
(b) injecting a molten plastic material into the lens-forming cavity under an injection pressure while maintaining the first and second molds at a melting temperature of the plastic material;
(c) cooling the molten plastic material so as to form a rimless eyeglass lens that has a shape corresponding to that of the lens-forming cavity and that is formed with a pair of through-hole units corresponding to the pin units and being respectively located at opposite inner and outer sides of the rimless eyeglass lens;
(d) repeating steps (a) to (c) so as to obtain another rimless eyeglass lens; and
(e) providing a bridge unit, a pair of temple units and a plurality of fixing units, the bridge unit and the temple units being connected to the rimless eyeglass lenses through the fixing units.

9. The method as claimed in claim 8, wherein the bridge unit is made by metal injection molding and includes a bridge member, two pad members extending from the bridge member, and a pair of bridge engaging members disposed on the bridge member opposite to each other, each of the fixing units being made of an elastic material by injection molding and having a base member and a coupling member that extends from the base member and that is snugly fitted into a respective one of the through-hole units, the bridge engaging members of the bridge unit tightly and respectively engaging; the coupling members of two of the fixing units that are respectively and snugly fitted into the through-hole units respectively located at the inner sides of the rimless eyeglass lenses so as to firmly connect the bridge unit to the inner sides of the rimless eyeglass lenses.

10. The method as claimed in claim 9, wherein each of the temple units is made by metal injection molding and includes a connecting member, a hinge member connected to one end of the connecting member, a temple engaging member disposed on another end of the connecting member, and a temple member pivotally connected to the hinge member, the temple engaging members of the temple units tightly and respectively engaging the coupling members of two of the fixing units that are respectively and snugly fitted into the through-hole units located at the outer sides of the rimless eyeglass lenses.

11. The method as claimed in claim 8, wherein each of the pin units includes a pin having a cross section, the cross section of the pin having a first maximum width along an imaginary line passing trough centers of the pins of the two pin units, and a second maximum width in a direction perpendicular to the imaginary line, the first maximum width being larger than the second maximum width, so that each of the through-hole units has a through-hole that is configured as a wide hole.

12. The method as claimed in claim 11, wherein the bridge unit is made by metal injection molding and includes a bridge member, two pad members extending from the bridge member, and a pair of bridge engaging members disposed on the bridge member opposite to each other, each of the fixing units being made of an elastic material by injection molding and having a base member and a coupling member that extends from the base member and that is snugly fitted into a respective one of the through-hole units, the bridge engaging members of the bridge unit tightly and respectively engaging the coupling members of two of the fixing units that are respectively and snugly fitted into the through-hole units respectively located at the inner sides of the rimless eyeglass lenses so as to firmly connect the bridge unit to the inner sides of the rimless eyeglass lenses.

13. The method as claimed in claim 12, wherein each of the temple units is made by metal injection molding and includes a connecting member, a hinge member connected to one end of the connecting member, a temple engaging member disposed on another end of the connecting member, and a temple member pivotally connected to the hinge member, the temple engaging members of the temple units tightly and respectively engaging the coupling members of two of the fixing units that are respectively and snugly fitted info the through-hole units located at the outer sides of the rimless eyeglass lenses.

14. The method as claimed, in claim 8, wherein, the second mold further includes a peripheral wall extending from a peripheral region of the base toward the first mold, the at least one pin of each of the at least two pin units abutting against the peripheral wall.

15. The method as claimed in claim 14, wherein the at least one pin of each of the at least two pin units has a circle-shaped cross section, a rectangle-shaped cross section or a trapezoidal-shaped cross section.

16. The method as claimed in claim 14, wherein the bridge unit is made by metal injection molding and includes a bridge member, two pad members extending from the bridge member, and a pair of bridge engaging members disposed on the bridge member opposite to each other, each of the fixing units being made of an elastic material by injection molding and having a base member and a coupling member that extends from the base member and that is snugly fitted info a respective one of the through-hole units, the bridge engaging members of the bridge unit tightly and respectively engaging the coupling members of two of the fixing units that are respectively and snugly fitted into the through-hole units respectively located at the inner sides of the rimless eyeglass lenses so as to firmly connect the bridge unit to the inner sides of the rimless eyeglass lenses.

17. The method as claimed in claim 16, wherein each of the temple units is made by metal injection molding and includes a connecting member, a hinge member connected to one end of the connecting member, a temple engaging member disposed on another end of the connecting member, and a temple member pivotally connected to the hinge member, the temple engaging members of the temple units tightly and respectively engaging the coupling members of two of the fixing units that are respectively and snugly fitted into the through-hole units located at the outer sides of the rimless eyeglass lenses.

18. The method as claimed in claim 8, wherein, before step (e), the rimless eyeglass lenses are polished and cleaned.

19. The method as claimed in claim 8, wherein the melting temperature in step (b) ranges from 190° C. to 240° C., the injection pressure being 75 Pascal.

20. The method as claimed in claim 8, wherein each of the pin units includes two adjacent pins, each of the pins having a circle-shaped cross section, so that each of the through-hole units has a pair of circle-shaped through-holes.
